(19) United States
(12) Patent Application Publication
(10) Pub. No.: US 2026/0169773 A1
(43) Pub. Date: Jun. 18, 2026

(54) ML-BASED PERFORMANCE OPTIMIZATION FRAMEWORK FOR RUNTIME ENVIRONMENTS ACROSS MULTIPLE PROGRAMMING LANGUAGES

(71) Applicant: HEWLETT PACKARD ENTERPRISE DEVELOPMENT LP, Spring, TX (US)

(72) Inventors: Suma Mudakare Bheema Bhat, Bangalore (IN); Ashish Dange, Bangalore (IN); Supriya Kamthania, Bangalore (IN)

(21) Appl. No.: 19/066,321

(22) Filed: Feb. 28, 2025

(30) Foreign Application Priority Data
Dec. 13, 2024 (IN) 202441098882

(51) Int. Cl. G06F 9/455; G06F 9/50

(52) U.S. Cl. CPC G06F 9/45516; G06F 9/5066

(57) ABSTRACT

Systems and methods are provided for adjusting runtime environments for optimizing performance. For example, the system can deploy a monitoring agent configured to collect a metrics of a runtime environment and provide them as input to a first machine learning model that outputs a pattern in the metric of the runtime environment. The output is provided to a second model that compares the pattern with a metric threshold. In response to the comparison, the system may determine an adjustment to the parameter that changes memory management or compilation strategies of the device. The system may also receive real-time feedback of an effect of the adjustment in the runtime environment and retrain the second model with the real-time feedback.

### BACKGROUND

Traditional system design includes automated processes for managing memory that is accessed by software applications at the client device. For example, the system design can include memory allocation and deallocation processes that identify and remove unused virtual objects. This automated process frees up memory for the software application to use and it eliminates the need for programmers to manually deallocate memory. While more recent programming languages provide this automated process of garbage collection, some legacy programming languages do not.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility or other organization, in accordance with examples discussed herein.

FIG. 2 is an illustrative computing component configured to optimize performance in a runtime environment across multiple programming languages, in accordance with examples discussed herein.

FIG. 3 is an illustrative client device monitored by the computing component, in accordance with examples discussed herein.

FIG. 4 illustrates a process that optimizes performance in a runtime environment across multiple programming languages, in accordance with examples discussed herein.

FIG. 5 is a computing component that may be used to implement examples of the disclosed technology.

FIG. 6 depicts a block diagram of an example computer system in which various examples of the disclosed technology described herein may be implemented.

The figures are not exhaustive and do not limit the present disclosure to the precise form disclosed.

### DETAILED DESCRIPTION

Some improvements to traditional systems can automatically tune/adjust parameters that are incorporated with applications installed on the system. These automated tuning procedures can be incorporated with some programming languages, but not all languages. For example, when the application is written in Java® or .NET® programming languages, the programming language many automatically implement garbage collection, whereas when the application is written in C or C++, no automatic garbage collection may be implemented. In either example or even when the application includes an automated tuning process, improvements can be made to the process of adjusting these parameters. For example, the automated tuning process may provide static reconfiguration of the parameters that cannot adapt to changing workload conditions in real-time, resulting in inefficient resource utilization and potential performance bottlenecks during peak usage periods.

Examples of the current disclosure can adjust parameters to optimize and improve system/application performance, irrespective of the programming language. “Parameters” may refer to specific settings or values that can be adjusted within a system to influence its behavior. In the context of garbage collection, parameters may include garbage collection algorithms (e.g., G1), heap sizes, memory allocation limits, and tuning settings. “Settings” refer to the configuration options applied within a system that dictate how it operates under certain conditions. This includes garbage collection settings, thread pool sizes, cache configurations, and database connection pooling. Settings can be manually adjusted or automatically optimized based on runtime data and identified metrics. “Runtime data” is the information collected during the execution of a system or application, providing real-time insights into its performance and operational state. This data includes metrics like garbage collection pause times, memory consumption, and object allocation events, which are analyzed to inform dynamic adjustments and optimizations in system performance.

“Metrics” are quantifiable measures used to assess the performance of a system. In the context of garbage collection, metrics may include object allocation rates, memory usage patterns, and garbage collection pause durations. Memory management configurations can be detected by monitoring memory allocation and deallocation values, object lifetimes, and memory pool sizes. Compilation options may be determined by monitoring specific compiler flags, thread pool sizes (e.g., affecting resource utilization), cache sizes, data retrieval speeds, and eviction policies. Database connection pooling and database retrieval/storage may be affected by the connection pool sizes and timeout settings. Input/output (I/O) parameters, such as buffer sizes and asynchronous processing options, may adjust metrics such as read, write, and other input/output operations. Other metrics may be determined as well, including load balancing settings (e.g., affecting how traffic is distributed across services or resources), latency thresholds (e.g., identifying acceptable limits for operational delays), and resource limit values for CPU, memory, and disk usage. These metrics provide insights that guide adjustments to optimize performance across different programming languages.

In view of this context, the system may implement an agent for monitoring metrics that are changeable during execution of the runtime environment of the client device (e.g., JVM for Java, CLR for .NET, or Python runtime). Different programming languages may adjust these metrics differently and automatically. The pattern of parameter adjustments may be identified by a first ML model that is trained to detect these patterns and identify the characteristics of the system that is affecting these metrics. A second ML model may predict optimal settings and suggest modifications for memory management, compilation strategies, and other runtime parameters. This analysis can be based on both historical and current system data.

Output of the monitoring agent may provide adaptive feedback and tune the parameters for improved performance of the system. For example, the output of the second machine learning model can provide real-time feedback by adjusting parameters in the runtime environment and monitoring changing concurrently with the monitoring agent (e.g., memory management, compilation strategies, etc.). The feedback may comprise information on the effects of the adjustment to the parameter, including changes to error handling or recovery mechanisms of the device. This combination allows for dynamic adjustments to the parameters and tracking of the metrics as they change in response. The use of the first and second machine learning models can supplement or replace traditional manual tuning of these parameters, in examples where automated tuning is provided, or provide new automated tuning with languages that do not implement the automated process.

As an illustrative example, metrics may be collected/stored by the monitoring agent and analyzed by machine learning models. The first ML model may identify a pattern of an increased object allocation rate that exceeds a metric threshold and the second ML model may identify that a longer garbage collection pause time is needed during peak traffic periods. Once specific metrics are identified, the system can automatically adjust the settings via a parameter tuning process (e.g., garbage collection settings, memory management mechanisms, and compilation parameters). Adjustment of these settings causes adjustments to the overall system, while the adaptive feedback may iteratively measure the system performance. The iterative feedback may help ensure that the system automatically learns and adapts to these conditions, maintaining optimal performance.

In some examples, the automatic adjustment of parameters may be based on defined rules or learned behaviors. For example, if the workload consistently exhibits high allocation rates, the system might determine to increase the heap size or switch to a more efficient garbage collection algorithm to reduce pause times. This dynamic tuning can occur in real-time, allowing the system to respond to changing conditions (e.g., a spike in user activity) without manual intervention. By continually learning from the data, the framework ensures optimal performance even as workloads and system demands evolve.

The feedback/adjustment may be programming language agnostic. For example, in Java, memory usage patterns might show that frequent minor garbage collection events are triggered due to high object allocation rates in a web application, necessitating tuning of the heap size or garbage collection algorithm. In contrast, in .NET applications, similar metrics might reveal that long garbage collection pauses occur when large objects are frequently allocated and deallocated, prompting a different set of adjustments, like modifying the large object heap settings. Moreover, common metrics like object allocation rates, heap size, and garbage collection pause durations can be relevant across multiple languages. For instance, whether in Java, Python, or C#, high object allocation rates can indicate the need for increased memory capacity or a change in the garbage collection strategy.

Technical improvements are described throughout the disclosure. For example, traditional systems may often rely on trial and error to adjust system/application parameters, leading to potential oversight of smaller yet significant parameters that, when neglected, can accumulate and create larger performance issues over time. The disclosed system can identify inefficiencies across multiple programming languages and automatically adjust parameters of the system to continuously improve the system. The metrics are stored in a centralized metrics database to aggregate performance data from different languages, enabling cross-language analysis and insights. In some examples, updated metrics may be shared between other systems across a network and the models from multiple systems can be retrained with the new metrics. This can help ensure that the model's recommendations are up-to-date with the evolving workload conditions.

In some examples, a real-time feedback loop is implemented. By continuously monitoring runtime environments and adjusting parameters in response to changing workload conditions, the system ensures sustained optimal performance. This adaptive mechanism allows the system to autonomously respond to varying demands without requiring human intervention, ensuring that applications run efficiently.

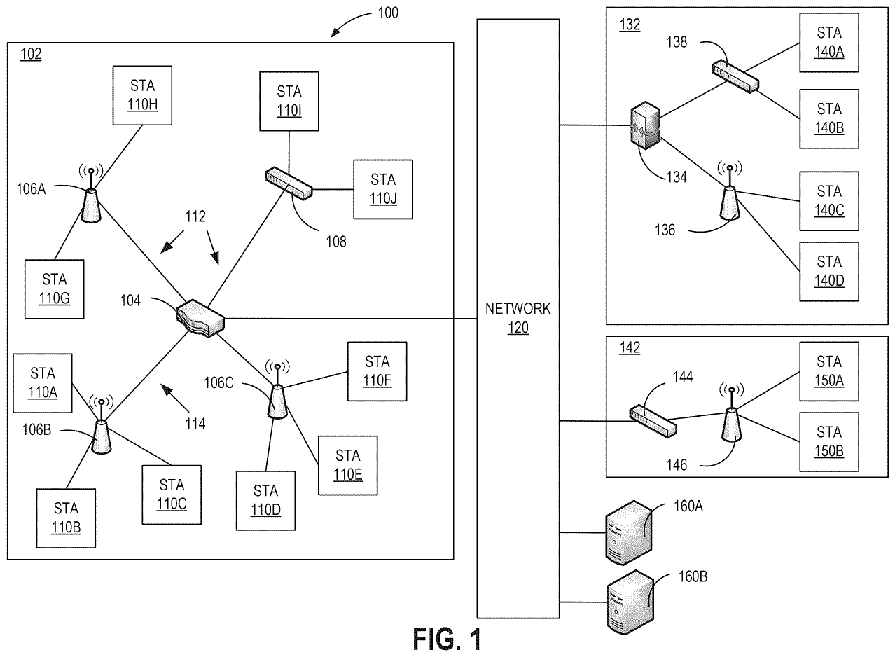

Before describing various examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. Network configuration 100 may include primary site 102 in communication with network 120. Network configuration 100 may also include one or more remote sites 132, 142, that are in communication with the network 120. The monitoring agent may be implemented at any of multiple client devices 110 from any of the multiple physical or geographical sites 102, 132, 142, or may be implemented at a remote location that monitors client devices 110. In either of these examples, a system at primary site 102 may implement an insights engine and auto tuner, as well as determine adaptive feedback, that receives information from the monitoring agent, as described throughout the application. In some examples, the monitoring agent, insights engine, auto tuner, and adaptive feedback are all implemented at the same device.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes controller 104, which is in communication with network 120. Controller 104 may provide communication with network 120 for primary site 102. There may be other points of communication with network 120 for primary site 102 in addition to controller 104. Although single device associated with controller 104 is illustrated, primary site 102 may include multiple controllers and/or multiple communication points with network 120. In some examples, controller 104 may communicate with network 120 through a router. In other examples, controller 104 provides router functionality to the devices in primary site 102. In this specification, the word “tunnel” refers to an encapsulated mode of transporting data between AP and controller.

Controller 104 may be operable to configure and manage network devices, such as at primary site 102, and may also manage network devices at remote sites 132, 142. Controller 104 may be operable to configure and/or manage switches, routers, access points, and/or client devices connected to a network. Controller 104 may itself be, or provide the functionality of, an Access Point (AP).

Controller 104 may be in communication with one or more switches 108 and/or wireless Access Points (APs) 106a-c. Switches 108 and wireless APs 106a-c provide network connectivity to various client devices 110a-j. Using a connection to switch 108 or AP 106a-c, client device 110a-j may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within primary site 102, switch 108 is included as one example of a point of access to the network established in primary site 102 for wired client devices 110i-j. Client devices 110i-j may connect to switch 108 and through switch 108, may be able to access other devices within network configuration 100. Client devices 110i-j may also be able to access network 120, through switch 108. Client devices 110i-j may communicate with switch 108 over a wired or wireless connection 112. In the illustrated example, switch 108 communicates with controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by controller 104. APs 106a-c communicate with controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with network 120. Gateway device 134 may be a router, a digital-to-analog modem, a cable modem, a digital subscriber line (DSL) modem, or some other network device configured to communicate with network 120. Remote site 132 may also include switch 138 and/or AP 136 in communication with gateway device 134 over either wired or wireless connections. Switch 138 and AP 136 provide connectivity to the network for various client devices 140a-d.

In various examples, remote site 132 may be in direct communication with primary site 102, such that client devices 140a-d at remote site 132 access the network resources at primary site 102 as if these client devices 140a-d were located at primary site 102. In such examples, remote site 132 is managed by controller 104 at primary site 102, and controller 104 provides the necessary connectivity, security, and accessibility that enable the connection between remote site 132 and primary site 102. Once connected to primary site 102, remote site 132 may function as a part of a private network provided by primary site 102.

In various examples, network configuration 100 may include one or more smaller remote sites 142, comprising only gateway device 144 for communicating with network 120 and wireless AP 146, by which various client devices 150a-b access network 120. Examples of remote site 142 may represent, for example, an individual employee's home or a temporary remote office. Remote site 142 may also be in communication with primary site 102, such that client devices 150a-b at remote site 142 access network resources at primary site 102 as if these client devices 150a-b were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among various sites 102, 132, 142 as well as access to servers 160a-b. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities. Network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. Client devices 110a-j, 140a-d, 150a-b may request and access the multimedia content provided by content servers 160a-b.

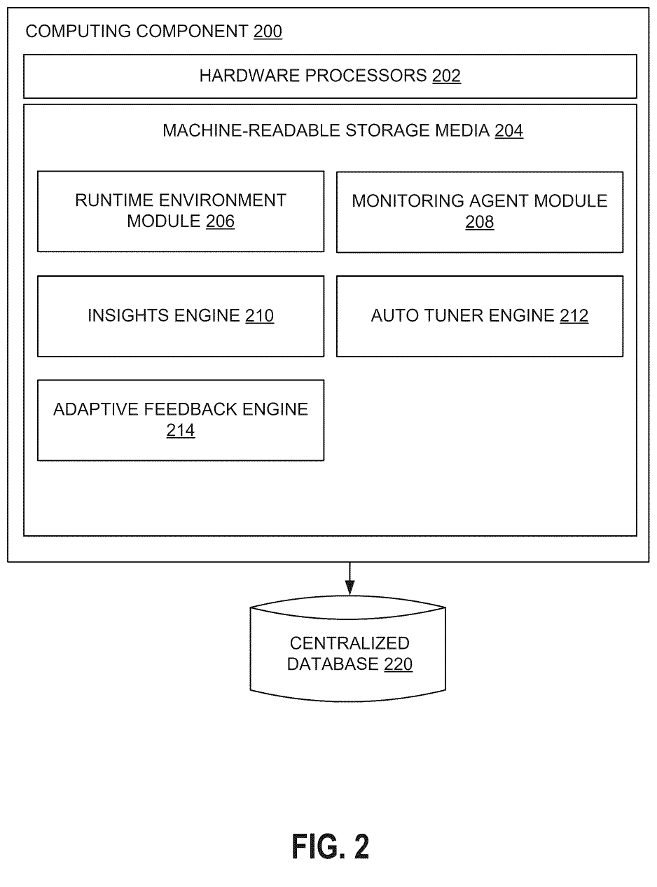

FIG. 2 is an illustrative computing component configured to optimize performance in a runtime environment across multiple programming languages, in accordance with examples discussed herein. For example, computing component 200 may be a server computer, a controller, or any other similar computing component capable of processing data from a client device (e.g., client devices 110 in FIG. 1) received via a communication network (e.g., network 120 in FIG. 1).

In the example implementation of FIG. 2, the computing component 200 includes hardware processor 202 and machine-readable storage medium 204. Machine-readable storage medium 204 comprises several modules and engines configured to perform the operations discussed throughout the disclosure, including runtime environment module 206, monitoring agent module 208, insights engine 210, auto tuner engine 212, and adaptive feedback engine 214. Computing component 200 may be in communication with a centralized database 220.

Runtime environment module 206 is configured to create objects that operate a software application and may be removed from the runtime environment when execution of the software application completes. These objects may be stored and removed, in some examples, by a garbage collector module. Based on the programming language that is used to generate/execute the software application, the garbage collector may be automatically executed (e.g., Java) or the garbage collector may be manually generated by adding software code to the application by an application programmer (e.g., C and C++). When the garbage collector is manually generated, the software application may comprise software code that explicitly identifies and deletes/purges the object from the memory. For example, the garbage collection process may access/probe the memory and maintain a list of data objects that are no longer needed. At a determined time, the garbage collector (e.g., in either the pre-implemented process or manually-generated process) may purge the object as to free up the memory for the running application to create new objects or new instances of the memory objects.

Runtime environment module 206 is also configured to execute computer implemented instructions to provide a runtime environment and execute software applications within the runtime environment. The runtime environment may be associated with JVM for Java®, CLR for .NET®, Python®. Other runtime environments may be implemented. For example, these runtime environments may implement a garbage collector that is automatically executed.

Runtime environment module 206 is also configured to generate runtime metrics that reflect its performance and the resource usage. The metrics may correspond with quantifiable measures used to assess the performance of a system. The context of the performance may be measured during execution of the runtime environment with respect to performance and resource usage of the system. For example, the metric may be a garbage collection pause time, memory usage, compilation statistic, or CPU/memory/I/O usage. In some examples, the metric is a heap size. In some examples, the metric is a memory allocation and deallocation values, object lifetimes, and memory pool sizes. In some examples, the metric is a binary measurement of the activation and deactivation of a compiler flag or eviction policy, or the metric is variable values like thread pool sizes, cache sizes, or data retrieval speeds.

Monitoring agent module 208 is configured to deploy a monitoring agent within various runtime environments, such as JVM for Java, CLR for .NET, and Python runtime. The monitoring agent may collect detailed runtime metrics, including garbage collection pause times, memory usage, compilation statistics, CPU usage, memory usage, and input/output (I/O) usage. The metrics may be stored in centralized database 220.

Monitoring agent module 208 is also configured to deploy a monitoring agent remotely at a client device (e.g., as a daemon program) or locally at computing component 200 (e.g., as an agent in a cloud computing environment). When the agent is deployed remotely, the user of the remote client device may download the agent from monitoring agent module 208 (e.g., via an API) or the agent may be transmitted to the client device. The monitoring agent is configured to collect a value/parameter of the metric that affects a runtime environment of the client device. For example, the monitoring agent may access a list of processes or applications that are executed in the runtime environment. The monitoring agent may identify applications that perform I/O operations.

In some examples, a list of applications may be stored in centralized database 220 and updated with runtime metrics as they occur. The list may identify the applications that interact/update the metrics as active applications. In some examples, the list of applications may be stored in a settings file or configuration file and identify the applications that will be monitored.

In some examples, other information is stored in centralized database 220 and updated with runtime metrics as they occur. The information may comprise, for example, all parameters, adjustments, feedback, and operational history in centralized database 220 for machine learning (ML) training, system improvement, and auditing.

Insights engine 210 is configured to identify the parameters that are accessed in the runtime environment as a correlation to the programming languages that are implemented in software applications. As discussed herein, when the application is executed, parameters like class loading and garbage collection are initiated. When these parameters are enabled for the application, metrics associated with the parameters may be tracked, including the throughput and garbage collection post time.

The correlation between the parameters/metrics and the programming languages may be identified by a first machine learning model or pattern detection algorithm. For example, insights engine 210 is configured to receive the metric from the monitoring agent and provide the runtime data associated with the metric as input to a first machine learning model. The first machine learning model may identify a pattern in the runtime data as output.

The first machine learning model may be a decision tree, neural network, support vector machine, or other machine learning model or pattern detection algorithm that can detect patterns in the metrics from the runtime environment. In each of these examples, insights engine 210 may preprocess the input by cleaning it (e.g., remove duplicates and outliers in the data) and encoding the data to convert categorical variables into numerical format. In some examples, insights engine 210 may also standardize the data by scaling the numerical features along a relative/common range.

When a decision tree is implemented, insights engine 210 may generate the tree through a training process after the data are preprocessed. First, insights engine 210 may determine a splitting criterion for the decision tree. The splitting criterion may comprise a Gini impurity or entropy for classification tasks, and mean squared error for regression tasks. In some examples, recursive splitting is implemented for the decision tree. In this instance, insights engine 210 may start from the root node and split the dataset based on the feature that results in the best split according to the chosen criterion. Insights engine 210 may repeat the splitting recursively for each child node until stopping conditions are met (e.g., maximum depth, minimum samples per leaf, or no further improvement). After building the tree, insights engine 210 may prune the tree by removing branches that have little importance or that do not provide predictive power in excess of a threshold value.

In some examples, the parameters of the tree may be optimized through a hyperparameter tuning process. The process may vary by implementation. Some parameters that may be optimized during the hyperparameter tuning process include maximum depth, minimum samples per leaf, and splitting criteria using techniques like grid search or random search to improve model performance.

When a neural network is implemented as the first machine learning model, insights engine 210 may define the structure of the network, including the number of layers, types of layers (e.g., dense, convolutional, recurrent), and the number of neurons in each layer during a training process after the data are preprocessed. Other features of the neural network may also be determined, including the activation functions for each layer of the neural network (e.g., ReLU, sigmoid, softmax), loss function (e.g., categorical cross-entropy for classification), optimization algorithm to update weights during training (e.g., SGD), and metrics to monitor model performance (e.g., accuracy, precision).

In some examples, the neural network may be trained through a series of steps executed by insights engine 210. The training process may comprise a forward pass (e.g., input data is fed through the network, producing an output), loss calculation (e.g., compare the predicted output with the true labels), backpropagation (e.g., calculate gradients of the loss with respect to the model's weights), and update the weights using the optimizer based on the computed gradients. The forward and backward pass may be repeated for a specified number of epochs.

When a support vector machine (SVM) is implemented as the first machine learning model, insights engine 210 may choose the appropriate kernel function based on the format of the metrics being analyzed in the runtime environment (e.g., linear kernel, polynomial kernel, or Radial Basis Function (RBF) kernel). Insights engine 210 may formulate the optimization problem to maximize the margin between the classes while minimizing classification errors, and identify the support vectors (e.g., the data points that are located closest to the decision boundary). Using this information, the training may implement hyperparameter tuning, which implements a grid search or random search to find optimal values for the parameters of the model.

Using any of the decision tree, neural network, support vector machine, or other machine learning model or pattern detection algorithm as the first machine learning model, insights engine 210 may detect patterns in the metrics from the runtime environment. The patterns may align with one or more programming languages that was used to create the application at the client device.

In some examples, insights engine 210 may compare the pattern in the metric with a metric threshold. Insights engine 210 may identify the parameters/metrics and flag the parameters that exceed the threshold (e.g., highly utilized), and the metrics that exceed the threshold may be provided to the second machine learning model for adjustment.

Various threshold values may be used. For example, the garbage collection process may be initiated or triggered when the heap/memory exceeds a threshold value. In some examples, the garbage collector may stop any application that is accessing the heap/memory so that all of the unused memory is released. Since the applications may be stopped, the processing of the system overall may run slower, corresponding with the garbage collection pause time.

Insights engine 210 is also configured to receive the output from the first machine learning model and provide it to a second machine learning model. For example, the input to the second machine learning model may include an identification of the programming language correlated to the pattern identified in the metric. The second machine learning model may be tuned to the programming language, so that optimizations generated by the second machine learning model correspond with parameters in the programming language. In this way, insights engine 210 is comparing the thresholds associated with the particular type of runtime environment to identify how it could be improved using the second machine learning model.

The second machine learning model may be gradient descent or other machine learning model or optimization algorithm that can determine an adjustment value for the metric and improve operations in the runtime environment. In each of these examples, insights engine 210 may preprocess the input by cleaning it (e.g., remove duplicates and outliers in the data) and encoding the data to convert categorical variables into numerical format. In some examples, insights engine 210 may also standardize the data by scaling the numerical features along a relative/common range.

When gradient descent is implemented, insights engine 210 may select a machine learning model (e.g., linear regression, logistic regression, neural networks) that uses gradient descent for optimization after the data are preprocessed. During the training process, insights engine 210 may determine a loss function that quantifies the difference between predicted and actual values (e.g., Mean Squared Error (MSE) for regression, Binary Cross-Entropy for binary classification, or Categorical Cross-Entropy for multi-class classification). Insights engine 210 may also initialize the model parameters (e.g., weights and biases) randomly or with zeros. The training phase may also comprise a forward pass (e.g. compute predictions using the current model parameters on the training dataset), loss calculation (e.g., evaluate the loss using the defined loss function to quantify how well the model is performing), and backward pass (e.g., compute the gradient of the loss function with respect to the model parameters). The parameters may be updated based on this process, then repeated for a specified number of epochs or until convergence is reached.

Using the second trained machine learning model, insights engine 210 may determine an adjustment to the parameter at the client device that changes memory management, compilation strategies, or a runtime parameter value of the client device. The adjustment value may correspond with the optimized convergence value identified by the gradient descent model.

In some examples, dynamic thread adjustments are implemented. For example, insights engine 210 may determine an adjustment to the thread pool and the implementation of the adjustment may automatically be executed. In response to the dynamic adjustment to the thread pool size, the resource utilization may also be affected/adjusted.

Insights engine 210 is also configured to retrain the first or second machine learning model. For example, the second machine learning model may be retrained with the real-time feedback to change the adjustment to the parameter to comply with new data or changing operating patterns in the environment.

Auto tuner engine 212 is configured to implement the adjustment to the parameter at the client device that changes memory management, compilation strategies, or a runtime parameter value of the client device. For example, the adjustment may add more space to the memory by adjusting the memory partition or adding virtual memory on a shared platform. In some examples, the adjustment may be implemented in response to the comparison of the metric with the metric threshold.

Adaptive feedback engine 214 is configured to receive real-time feedback of an effect of the adjustment to the parameter that changes the memory management, compilation strategies, or runtime parameter value of the client device. For example, as new data are added to centralized database 220, real-time feedback is determined as changes in the runtime data (e.g., by comparing historical data to current data).

Adaptive feedback engine 214 is configured to retrain the first or second machine learning model. For example, the second machine learning model may be retrained with new performance data to identify different adjustments to the parameters, which cause different effects to the quantified metrics in the system. This may help ensure that the adjustments determined by the second machine learning model are up-to-date and adapted to evolving workload conditions.

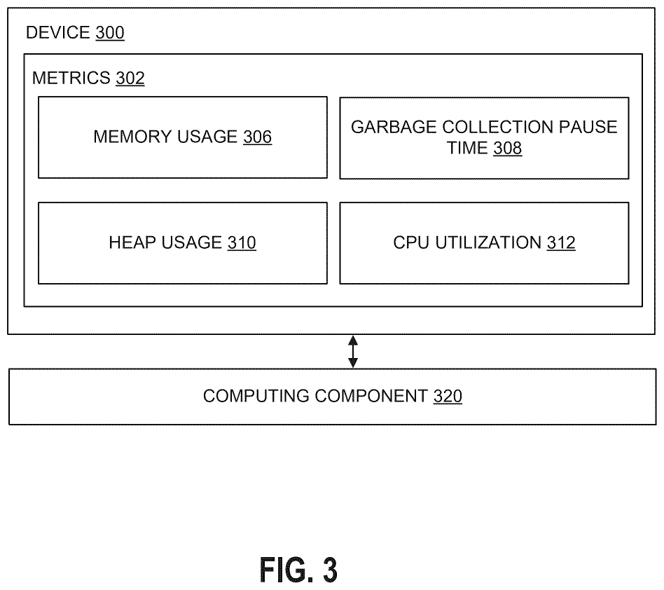

FIG. 3 is an illustrative client device monitored by the computing component, in accordance with examples discussed herein. For example, device 300 comprises a set of metrics 302 that are adjusted by different processes. In this example, metrics 302 comprise memory usage 306, garbage collection pause time 308, heap usage 310, and CPU utilization 312. Computing component 320 may interact with device 300 to monitor metrics 302. In some examples, computing component 320 is implemented at device 300 to locally monitor and adjust the settings at device 300. In some examples, computing component 320 may correspond with computing component 200 illustrated in FIG. 2.

In a first illustrative example, device 300 comprises an e-commerce application that is monitored and adjusted during a peak load time. The e-commerce application that is executed at device 300 is developed using a combination of Java and .NET programming languages.

The e-commerce application may experience high network traffic during holiday sales, leading to increased memory usage 306 and frequent garbage collection pause times 308. The monitoring agent from computing component 320 is running locally at device 300 and storing data during the high traffic time, including memory usage 306, garbage collection pause times 308, heap usage 310, and CPU utilization 312.

Computing component 320 may analyze the metrics and output from the model. The output may identify adjustments to the metrics to improve the operations of the device. The adjustments may comprise, for example, switching from a current garbage collection process (e.g., parallel GC) to a Garbage First Garbage Collector (G1GC) process in Java, adjusting the heap size (e.g., maximum heap size from 4 GB to 6 GB), and changing the .NET garbage collector settings (e.g., adjust the garbage collection latency mode to optimize operations for low latency during a peak load range). In some examples, the heap size can be increased by a percentage amount (e.g., increased by 50 percent). The adjustments to metrics 302 are monitored and identified to reduce the garbage collection pause time 308 and improve throughput. As a result, the e-commerce application at device 300 handles the peak load more efficiently with reduced latency and improved user experience.

In a second illustrative example, device 300 comprises a financial services application that is monitored and adjusted during a variable load time. The financial services application that is executed at device 300 is developed using a combination of Python and Ruby programming languages.

The financial services application may experience varying processing loads throughout the day, with peak transactions during market hours and lower activity during off-hours. The monitoring agent from computing component 320 is running locally at device 300 and storing data during this time, including effects to metrics 302 like memory usage 306, garbage collection pause times 308, heap usage 310, and CPU utilization 312.

Computing component 320 may analyze the metrics and output from the model. The output may identify adjustments to the metrics to improve the operations of the device. The adjustments may be implemented based on a time frame. For example, during peak times, the adjustments may comprise, for example, adjusting memory allocation strategies to reduce fragmentation in Python, switching to a more aggressive garbage collection algorithm that minimizes the pause times, and increasing the thread pool size to handle more concurrent transactions. During off-peak times, the adjustments may comprise reverting the memory allocation strategies to a more conservative process in Python, switch back to a less aggressive garbage collection algorithm that conserves CPU resources rather than reducing pause times, and reducing the thread pool size to conserve resources. This dynamic adjustment ensures that the application maintains optimal performance, reduces costs and resource consumption, and meets the demands of variable load conditions at device 300.

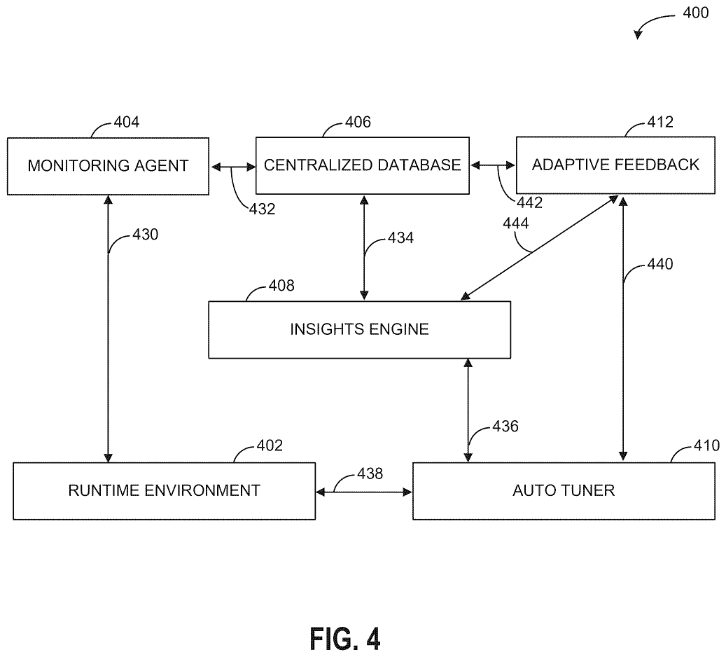

FIG. 4 illustrates a process that optimizes performance in a runtime environment across multiple programming languages, in accordance with examples discussed herein. In example 400, modules and engines that are illustrated in FIG. 2 are provided in FIG. 4. For example, runtime environment module 206, monitoring agent module 208, insights engine 210, auto tuner engine 212, and adaptive feedback engine 214 in FIG. 2 corresponds with runtime environment 402, monitoring agent 404, insights engine 408, auto tuner 410, and adaptive feedback 412, respectively. Various data are stored in centralized database 406, including data described as being stored with centralized database 220 in FIG. 2.

At block 430, monitoring agent 404 collects runtime metrics from runtime environment 402. This includes data such as garbage collection, pause times, memory usage, CPU utilization, input-output statistics, and other metrics. Runtime environments may comprise, for example, JVM for Java, CLR for .NET, and Python runtime, each of which may alter runtime metrics that are identified/determined by monitoring agent 404.

At block 432, monitoring agent 404 stores the runtime metrics from runtime environment 402 at centralized database 406. Centralized database 406 may act as a storage hub for the runtime metrics gathered from various environments, including runtime environment 402. In some examples, centralized database 406 stores detailed runtime metrics from various environments.

At block 434, insights engine 408 accesses centralized database 406 for the stored metrics. Insights engine 408 may provide the metrics as input to a first machine learning model. The first machine learning model may analyze the collected runtime data to identify the patterns and trends. In some examples, the output of the first machine learning model is provided to a second machine learning model. The second machine learning model may predict an optimal setting for memory management, improved settings for compilation strategies, and adjustments to other runtime parameters.

At block 436, insights engine 408 transmits the output/optimization values to auto tuner 410. In some examples, auto tuner 410 may correlate the suggested adjustments to parameters and settings in runtime environment 402.

At block 438, auto tuner 410 interacts directly with runtime environment 402 to apply/adjust the parameters in runtime environment 402. For example, auto tuner 410 may dynamically adjust parameters that affect the garbage collection algorithms (e.g., corresponding with each application that implements a garbage collection), memory allocation processes, and compilation thresholds based on usage patterns.

As an illustrative example, when the runtime parameter is associated with garbage collection, auto tuner 410 may dynamically adjust the garbage collection algorithm in runtime environment 402. In another example, when the parameter is associated with memory allocation strategies, auto tuner 410 may dynamically adjust the memory allocation algorithm in runtime environment 402, based on the metrics identified by the data collected by monitoring agent 404 and analyzed/identified by insight engine 408.

Multiple parameters may be adjusted. For example, the first machine learning model may detect a pattern in the runtime data and the second machine learning model may determine five parameters that will be adjusted/tuned. The identified parameters may also correspond with dependent parameters identified in centralized database 406. In this instance, insight engine 408 may access the centralized database to determine metrics that may have changed from the previous iteration, then based on the output of the machine learning model(s), determine the adjusted values to the parameters.

Multiple environments may also be affected. For example, one hundred users may initially access the runtime environment and the updated data identifies one thousand users accessing the runtime environment. The runtime data may identify the change in users over a threshold amount. The system may adjust parameters may allow improved processing of the runtime environment for the increased number of users.

At block 440, auto tuner 410 transmits updated performance data back to adaptive feedback 412. The transmission of the updated data may implement a feedback loop to update centralized database 406 with new data (block 442) and continuously retrain the machine learning model to adapt it to evolving workload conditions (block 444).

At block 442, adaptive feedback 412 stores the updated data in centralized database 406. With the new performance data, the insight engine 408 may be retrained and updated, thus creating a cycle of ongoing optimization.

At block 444, the updated performance data may be used to retrain the ML model at insights engine 408 and improve predictions/adjustments to metrics in runtime environment 402. It may also ensure that the ML model remains relevant and effective in optimizing the performance and the workload conditions as they have evolved.

In some examples, adaptive feedback 412 supplements parameter tuning implemented by auto tuner 410 by implementing a supplemental monitoring process. For example, an initial monitoring process may identify and adjust/tune parameters, which were just analyzed and passed on to the auto tuner 410. In the supplemental monitoring process, the monitoring agent 404 and adaptive feedback 412 can detect each and every component at the client device for adjustments in performance metrics. As such, the monitoring can cover the tuned parameters and any parameters that have not been tuned within a threshold amount of time to help ensure adaptive and efficient performance of the client device.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

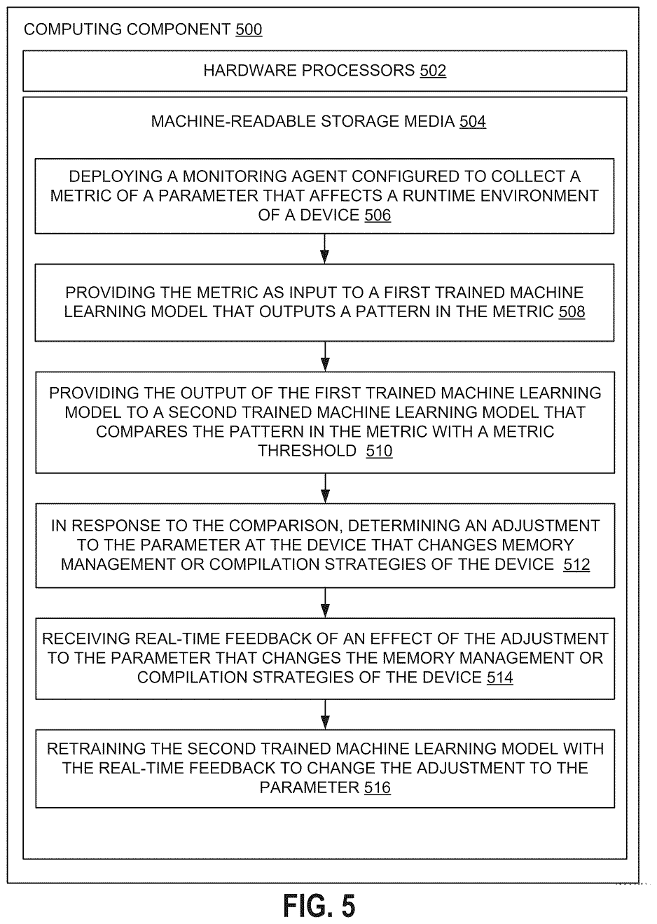

FIG. 5 illustrates a computing component that may be used to implement performance optimization for runtime environments across multiple programming languages, in accordance with various examples of the disclosed technology. For example, computing component 500 may be, for example, a server computer, a controller, or any other similar computing component capable of processing data. In the example implementation of FIG. 5, the computing component 500 includes hardware processor 502 and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-516, to control processes or operations for performance optimization for runtime environments across multiple programming languages. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-516.

Hardware processor 502 may execute instruction 506 to deploy a monitoring agent. The monitoring agent may be configured to collect a metric of a parameter that affects a runtime environment of a device. The runtime environment of the client device may correspond with various programming languages and environments, including JVM for Java, CLR for .NET, or Python runtime. The different programming languages may adjust these metrics differently and automatically.

Hardware processor 502 may execute instruction 508 to provide the metric as input to a first machine learning model. For example, the first machine learning model may be a decision tree, neural network, support vector machine, or other machine learning model or pattern detection algorithm that can detect patterns in the metrics from the runtime environment. In each of these examples, the input may be preprocessed by cleaning it (e.g., remove duplicates and outliers in the data) and encoding the data to convert categorical variables into numerical format. In some examples, the input may also be standardized by scaling the numerical features along a relative/common range.

The first machine learning model may output a pattern in the metric. The pattern may align with one or more programming languages that was used to create the application at the client device.

Hardware processor 502 may execute instruction 510 to provide the output of the first machine learning model to a second machine learning model. The second machine learning model may be configured to compare the pattern in the metric with a metric threshold. In some examples, the pattern in the metric may be compared with a metric threshold and the parameters/metrics that exceed the threshold (e.g., highly utilized) may be flagged or otherwise identified. The metrics that exceed the threshold may be provided to the second machine learning model for adjustment.

Various threshold values may be used. For example, the garbage collection process may be initiated or triggered when the heap/memory exceeds a threshold value. In some examples, the garbage collector may stop any application that is accessing the heap/memory so that all of the unused memory is released. Since the applications may be stopped, the processing of the system overall may run slower, corresponding with the garbage collection pause time.

Hardware processor 502 may execute instruction 512 to determine an adjustment to the parameter at the device that changes memory management or compilation strategies of the device. The adjustment may be determined in response to the comparison conducted by the second machine learning model.

Hardware processor 502 may execute instruction 514 to receive real-time feedback of an effect of the adjustment to the parameter that changes the memory management or compilation strategies of the device. In some examples, the effect of the adjustment may be provided in the real-time feedback associated with error handling or recovery mechanisms of the device.

Hardware processor 502 may execute instruction 516 to retrain the second machine learning model with the real-time feedback to change the adjustment to the parameter. For example, the second machine learning model may be retrained with the real-time feedback to change the adjustment to the parameter to comply with new data or changing operating patterns in the environment.

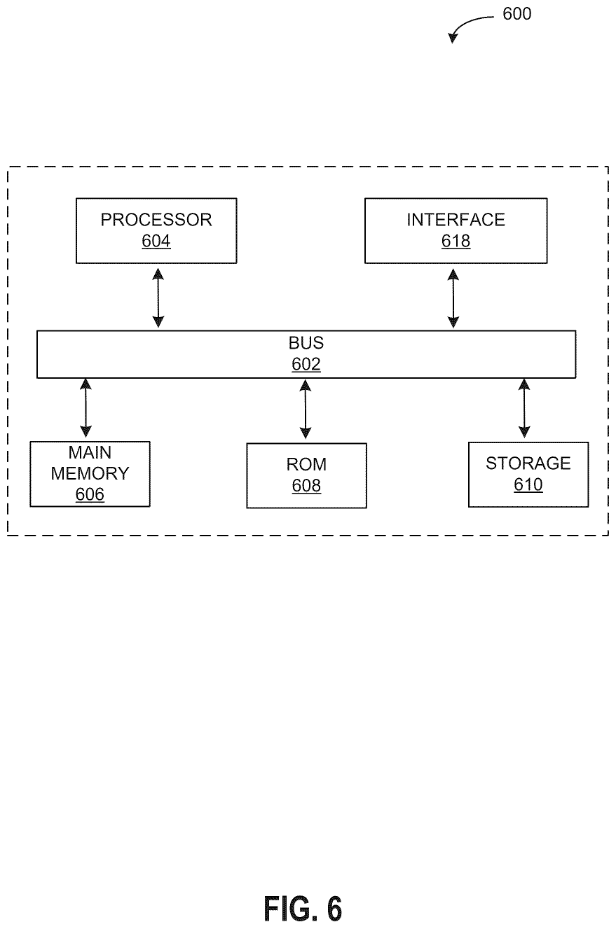

FIG. 6 depicts a block diagram of an example computer system 600 in which various examples of the disclosed technology described herein may be implemented. Computer system 600 includes bus 602 or other communication mechanism for communicating information, one or more hardware processors 604 coupled with bus 602 for processing information. Hardware processor(s) 604 may be, for example, one or more general purpose microprocessors.

Computer system 600 also includes main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes read only memory (ROM) 608 or other static storage device coupled to bus 602 for storing static information and instructions for processor 604. Storage device 610, such as a magnetic disk, optical disk, or USB thumb drive (Flash drive), etc., is provided and coupled to bus 602 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

Computer system 600 also includes interface 618 coupled to bus 602. Interface 618 provides a two-way data communication coupling to one or more network links that are connected to one or more local networks. For example, interface 618 may be an integrated services digital network (ISDN) card, cable modem, satellite modem, or a modem to provide a data communication connection to a corresponding type of telephone line. As another example, interface 618 may be a local area network (LAN) card to provide a data communication connection to a compatible LAN (or WAN component to communicate with a WAN). Wireless links may also be implemented. In any such implementation, interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 618, which carry the digital data to and from computer system 600, are example forms of transmission media.

Computer system 600 can send messages and receive data, including program code, through the network(s), network link and interface 618. In the Internet example, a server might transmit a requested code for an application program through the Internet, the ISP, the local network and interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
deploying a monitoring agent configured to collect a metric of a parameter that affects a runtime environment of a device;
providing the metric as input to a first machine learning model that outputs a pattern in the metric;
providing the output of the first machine learning model to a second machine learning model that compares the pattern in the metric with a metric threshold;
in response to the comparison, determining an adjustment to the parameter at the device that changes memory management or compilation strategies of the device;
receiving real-time feedback of an effect of the adjustment to the parameter that changes the memory management or compilation strategies of the device, the effect in the real-time feedback associated with error handling or recovery mechanisms of the device; and
retraining the second machine learning model with the real-time feedback to change the adjustment to the parameter.

2. The computer-implemented method of claim 1, wherein the runtime environment is associated with Java Virtual Machine (JVM) for Java®, Common Language Runtime (CLR) for .NET®, and Python®.

3. The computer-implemented method of claim 2, further comprising:
in response to the runtime environment being associated with JVM for Java®, automatically tuning a heap size or garbage collection algorithm.

4. The computer-implemented method of claim 2, further comprising:
in response to the runtime environment being associated with CLR for .NET®, automatically modifying a large object heap setting.

5. The computer-implemented method of claim 1, wherein the metric is a garbage collection pause time, memory usage, compilation statistic, or CPU/memory/I/O usage.

6. The computer-implemented method of claim 1, wherein the metric is a heap size and a maximum heap size is increased by 50 percent.

7. The computer-implemented method of claim 1, wherein the metric is a memory allocation and deallocation values, object lifetimes, and memory pool sizes.

8. The computer-implemented method of claim 1, wherein the metric is compiler flags, thread pool sizes, cache sizes, data retrieval speeds, and eviction policies.

9. A computer system comprising:
a memory storing instructions; and
a processor communicatively coupled to the memory and configured to execute the instructions to:
deploy a monitoring agent configured to collect a metric of a parameter that affects a runtime environment of a device;
provide the metric as input to a first machine learning model that outputs a pattern in the metric;
provide the output of the first machine learning model to a second machine learning model that compares the pattern in the metric with a metric threshold;
in response to the comparison, determine an adjustment to the parameter at the device that changes memory management or compilation strategies of the device;
receive real-time feedback of an effect of the adjustment to the parameter that changes the memory management or compilation strategies of the device; and
retrain the second machine learning model with the real-time feedback to change the adjustment to the parameter.

10. The computer system of claim 9, wherein the effect in the real-time feedback is associated with error handling or recovery mechanisms of the device.

11. The computer system of claim 9, wherein the runtime environment is associated with Java Virtual Machine (JVM) for Java®, Common Language Runtime (CLR) for .NET®, and Python®.

12. The computer system of claim 11, further comprising:
in response to the runtime environment being associated with JVM for Java®, automatically tuning a heap size or garbage collection algorithm.

13. The computer system of claim 11, further comprising:
in response to the runtime environment being associated with CLR for .NET®, automatically modifying a large object heap setting.

14. The computer system of claim 9, wherein the metric is a garbage collection pause time, memory usage, compilation statistic, or CPU/memory/I/O usage.

15. The computer system of claim 9, wherein the metric is a heap size and a maximum heap size is increased by 50 percent.

16. The computer system of claim 9, wherein the metric is a memory allocation and deallocation values, object lifetimes, and memory pool sizes.

17. The computer system of claim 9, wherein the metric is compiler flags, thread pool sizes, cache sizes, data retrieval speeds, and eviction policies.

18. A non-transitory computer-readable storage medium storing a plurality of instructions executable by a processor, the plurality of instructions when executed by the processor cause the processor to:
deploy a monitoring agent configured to collect a metric of a parameter that affects a runtime environment of a device;
provide the metric as input to a first machine learning model that outputs a pattern in the metric;
provide the output of the first machine learning model to a second machine learning model that compares the pattern in the metric with a metric threshold;
in response to the comparison, determine an adjustment to the parameter at the device that changes memory management or compilation strategies of the device;
receive real-time feedback of an effect of the adjustment to the parameter that changes the memory management or compilation strategies of the device; and
retrain the second machine learning model with the real-time feedback to change the adjustment to the parameter.

19. The non-transitory computer-readable storage medium of claim 15, wherein the metric is a garbage collection pause time, memory usage, compilation statistic, or CPU/memory/I/O usage.

20. The computer-implemented method of claim 1, wherein the metric is a heap size and a maximum heap size is increased by 50 percent.
